(19) United States
(12) Patent Application Publication
(10) Pub. No.: US 2020/0157971 A1
(43) Pub. Date: May 21, 2020

(54) STRUCTURAL ASSEMBLY FOR A GAS TURBINE ENGINE

(71) Applicant: Rolls-Royce Deutschland Ltd & Co KG, Blankenfelde-Mahlow (DE)

(72) Inventors: Carsten BUCHHOLZ, Berlin (DE); Martin KNÖPKE, Rangsdorf (DE)

(21) Appl. No.: 16/687,067

(22) Filed: Nov. 18, 2019

(30) Foreign Application Priority Data
Nov. 19, 2018 (DE) 10 2018 129 045.4

(51) Int. Cl. F01D 25/16; F02C 7/06; F16C 35/06

(52) U.S. Cl. CPC F01D 25/162; F02C 7/06; F05D 2220/36; F16C 2360/23; F05D 2240/50; F16C 35/06

(57) ABSTRACT

A structural subassembly for a gas turbine engine, includes: a bearing mounting a fan shaft, a bearing housing surrounding the bearing, and a bearing support housing surrounding the bearing housing at a radial distance and which is connected to a supporting structure of the engine. Upon loss of a fan blade, the bearing housing contacts the bearing support housing because of an eccentric revolving movement of the bearing housing. The bearing support housing forms an inner surface which faces the bearing housing and has at least two flat contact surfaces which are spaced apart in the circumferential direction. Upon loss of a fan blade, the bearing housing strikes against the at least two flat contact surfaces during each eccentric revolution, and which in regions outside the flat contact surfaces is spaced apart from the bearing housing such that there is no contact with the eccentrically revolving bearing housing.

This application claims priority to German Patent Application DE102018129045.4 filed Nov. 19, 2018, the entirety of which is incorporated by reference herein.

The invention relates to a structural subassembly for a gas turbine engine according to the preamble of Patent Claim 1 and to a gas turbine engine having a structural subassembly of this kind.

The loss of a fan blade of an engine, for example as a result of a bird strike or material fatigue, leads to extreme loads in the form of a large imbalance in the engine. This is associated with powerful revolving radial loads in the bearings of the fan shaft.

One of the problems associated with the loss of a fan blade arises from the fact that, after the loss of a fan blade, the engine typically passes into a “windmilling” mode. “Windmilling” refers to the turbine-equivalent behavior of the fan which is driven by the air flowing through the engine. In the windmilling mode, the fan rotates in a lower rotational speed range. Said rotational speed range coincides with a frequency range in which the supporting structures of the engine and/or the engine mount have resonances. The rotation in the resonance range causes greatly increased radial loads on the bearings and the supporting structures. This leads to increased load amplitudes which act on the engine mount of the engine.

R. Gasch et al.: Rotordynamik, 2nd Edition, 1975, Springer Verlag, pages 557 et seq. discloses connecting the bearing chambers of a front fan shaft bearing to a supporting structure of the engine via a plurality of shearing pins. Following loss of a blade, the shearing pins shear off, and therefore the connection between the bearing and the supporting structure is interrupted. The radial positioning of the fan shaft is subsequently taken over by a second bearing which is located axially behind the front bearing. Shearing off of the shearing pins reduces the initial loads, and the front bearing and the supporting structure can be constructed in a more weight-saving manner. However, such a constructional form is associated with the disadvantage of a changed resonance frequency since it is brought by the shearing off of the shearing pins into a lower rotational speed range which coincides precisely with the rotational speed range within which the engine rotates during windmilling.

U.S. Pat. No. 6,325,546 B1 discloses a structural subassembly in which a bearing housing of a fan shaft bearing is assigned a damper device which is connected to a structural component of the engine. The damper device here has an elliptically shaped damping ring composed of an elastic material, which has a varying thickness and surrounds the bearing housing at a radial distance varying in the circumferential direction. In the event of the loss of a fan blade, the bearing housing is placed onto the elliptically shaped damping ring and encircles along the inner surface thereof.

The present invention is based on the object of providing a structural subassembly for a gas turbine engine, in which the radial loads which occur in the event of the loss of a fan blade and act on the engine mount of the gas turbine engine are reduced.

This object is achieved by a structural subassembly having the features of Patent claim 1 and by a gas turbine engine having the features of Patent Claim 17. Refinements of the invention are indicated in the dependent claims.

According thereto, the invention considers a structural subassembly for a gas turbine engine. The structural subassembly comprises a bearing serving for the mounting of the fan shaft of a gas turbine engine, wherein the bearing comprises a static bearing element. The bearing is typically a rolling bearing, wherein the static bearing element is the outer ring of the rolling bearing. The structural subassembly furthermore comprises a bearing housing which surrounds the bearing, wherein the bearing housing is connected to the static bearing element or forms the latter. Furthermore, a bearing support housing is provided which surrounds the bearing housing at a radial distance and which is connected to a supporting structure of the gas turbine engine, for example to a fan housing. In the event of the loss of a fan blade, the bearing housing enters into contact with the bearing support housing because of an eccentric revolving movement of the bearing housing then occurring.

In such a structural subassembly, the invention makes provision for the bearing support housing to form an inner surface which faces the bearing housing and has at least two flat contact surfaces which are spaced apart in the circumferential direction, wherein, in the event of the loss of a fan blade, the bearing housing strikes against the at least two flat contact surfaces during each eccentric revolution. Furthermore, the inner surface facing the bearing housing is formed in such a manner that in regions outside the flat contact surfaces it is spaced apart from the bearing housing in such a manner that there is no contact with the eccentrically revolving bearing housing. Between the impacts of the bearing housing against the contact surfaces, the bearing housing is therefore detached from the inner surface of the bearing support housing during an eccentric revolution. This permits the striking, which in each case includes a detachment, against a contact surface.

The present invention is based on the concept of converting the vibrations of the first order of the bearing housing, which are triggered by the radial imbalance, into vibrations of a higher excitation order of the bearing support housing. This is achieved by at least two flat contact surfaces against which the bearing housing strikes during each revolution. The number of flat contact surfaces defines the degree of the excitation order, into which the vibrations of the bearing housing are converted. If the revolving bearing housing strikes against two contact surfaces during a revolution, this results in a second excitation order; if it strikes against three contact surfaces, this results in a third excitation order, etc.

By means of a special shape of the bearing support housing or of the contact surfaces provided by the latter, the invention therefore converts the vibrations of the first order acting on the bearing into radial vibrations of a higher order which are introduced into the supporting structure. The loading of the system and the loads introduced into the engine mount are thereby reduced.

It is the case here that the bearing and therefore the bearing housing carry out an eccentric revolving movement because of the imbalance introduced by the fan. The bearing housing enters here into contact with the bearing support housing. The effect achieved by the shape of the inner surface of the bearing support housing, said inner surface facing the bearing housing, is that this contact is limited to impacts against the contact surfaces. The repeating intermittent exertion of radial force in the bearing support housing and, by the latter, in the supporting structure of the engine changes the vibration pattern. By this means, the load amplitudes which the engine mount has to be able to withstand are reduced since the vibration energy which is normally concentrated in the first vibration order is divided between vibration orders of a higher order. The maximum loads acting on the engine mount are thereby reduced.

One refinement of the invention makes provision for the bearing support housing to have a contact sleeve which surrounds the bearing housing in the radial direction and forms the inner surface facing the bearing housing and the at least two flat contact surfaces in said inner surface. It is provided here that the contact sleeve surrounds the bearing housing over an angular range of 360° in a plane perpendicular to the axis of rotation of the fan shaft. The one or more contact surfaces are formed in the contact sleeve.

A further refinement of the invention makes provision for the bearing support housing to have two flat contact surfaces which run parallel to each other and are arranged lying opposite with respect to the axis of rotation of the fan shaft. The two contact surfaces are accordingly spaced apart by 180° in the circumferential direction. By the provision of two contact surfaces against which the bearing housing strikes during a revolution, vibrations of a second excitation order are produced.

It is the case here that the inner surface of the bearing support housing outside the flat contact surfaces is spaced apart from the bearing housing in such a manner that there is no contact with the eccentrically revolving bearing housing. The contact is therefore directionally dependent (in the direction of the two parallel contact surfaces). It can be provided here that the two contact surfaces are arranged in the horizontal direction. The terms horizontally and vertically relate to the orientation of the contact surfaces that the latter assume in a horizontally oriented engine.

A further refinement of the invention makes provision for the bearing support housing to have three flat contact surfaces. During a revolution of the bearing housing, the latter therefore strikes against three contact surfaces. Vibrations of a third excitation order are thereby produced.

A variant embodiment in this respect makes provision for the three flat contact surfaces in a sectional illustration perpendicular to the axis of rotation of the fan shaft to be oriented with respect to one another corresponding to the three sides of an equilateral triangle, wherein the axis of rotation of the fan shaft lies at the center point of the equilateral triangle. The contact surfaces are therefore each offset by 120° in the circumferential direction.

A further refinement of the invention makes provision for the bearing support housing to have four flat contact surfaces. During a revolution of the bearing housing, the latter therefore strikes against four contact surfaces. Vibrations of a fourth excitation order are thereby produced.

A variant embodiment in this respect makes provision for the four flat contact surfaces in a sectional illustration perpendicular to the axis of rotation of the fan shaft to be oriented with respect to one another corresponding to the four sides of a square, wherein the axis of rotation of the fan shaft lies at the center point of the square. The contact surfaces are therefore offset by 90° in the circumferential direction.

According to a further refinement of the invention, provision is made for the contact surfaces to be positioned in such a manner that vibrations of the bearing support housing that are produced by the impact of the bearing housing are produced with a defined preferred direction and are transported further via the bearing support housing. Such a preferred direction can be defined via the orientation of the contact surfaces in the circumferential direction. For example, provision can be made for two flat contact surfaces to be provided which are arranged parallel to each other and are rotated in the circumferential direction or counter to the circumferential direction by a defined angle in relation to a horizontal orientation. The radial loads then are not introduced into the bearing support housing in the vertical direction, but rather in the desired preferred direction.

A variant embodiment of the invention makes provision for the bearing housing and the bearing support housing to be connected to each other via shearing pins, wherein the shearing pins are designed in such a manner that they shear off in the event of the loss of a fan blade because of an eccentric revolving movement of the bearing housing then occurring. The use of shearing pins limits the transmission of radial loads into the supporting structure since, after shearing off of the shearing pins, the direct connection between the bearing and the supporting structure is interrupted and such a connection is then only provided by the intermittent coupling between the bearing housing and the bearing support housing.

The present invention is associated with the aim of converting the vibration of the first order acting on the bearing housing because of strikes or collisions with the at least two contact surfaces of the bearing support housing into vibrations of a higher order. For this purpose, it is expedient for the following two properties to be realized in refinements of the invention. Firstly, the contact surfaces should be sufficiently firm under the impact loading. This necessitates a high degree of ductility which is maintained even at high strain rates. As a rule, typical high-strength titanium and steel alloys satisfy this requirement. Secondly, the stiffness of the surrounding structure should be sufficiently stiff, specifically, for example, should be stiffer by at least one order than the most pliant region in the load path. The engine mount is typically so.

Furthermore, in refinements of the invention, the contact surfaces are not connected to a damping material or mounted in a floating manner, and therefore the contact surfaces do not have a damping effect. The impacts formed by the bearing housing against the contact surfaces are thereby effectively converted into vibrations of a higher order. In refinements of the invention, it is provided that the contact surfaces have a Vickers hardness of at least 300 HV 10, preferably a Vickers hardness of at least 400 HV 10.

The bearing housing naturally forms an outer surface which enters into contact with the bearing support housing. For this purpose, one refinement makes provision for the bearing housing to have a bearing housing contact surface which revolves by 360° and enters into contact with the contact surfaces of the bearing support housing during an eccentric revolving movement of the bearing housing. This bearing housing contact surface is in particular circular or substantially circular.

Provision can be made here for the bearing housing contact surface to be provided with a coating which increases the local yield strength of the bearing housing contact surface, wherein the yield strength refers to the stress up to which a material does not exhibit any permanent plastic deformation under a uniaxial and torque-free tensile stress. Such a coating prevents plasticization from being able to occur at the contact surface with the bearing support housing due to the high local stresses occurring upon a contact or impact. The coating can be undertaken, for example, with tungsten carbide.

In another aspect of the invention, the invention relates to a gas turbine engine having a structural subassembly according to the invention. Provision may be made here for the gas turbine engine to have:
an engine core which comprises a turbine, a compressor having a structural subassembly according to the invention, and a turbine shaft which is configured as a hollow shaft and connects the turbine to the compressor;
a fan which is positioned upstream of the engine core, wherein the fan comprises a plurality of fan blades; and
a gearbox that receives an input from the turbine shaft and outputs drive for the fan so as to drive the fan at a lower rotational speed than the turbine shaft.

One design embodiment in this regard may provide that
the turbine is a first turbine, the compressor is a first compressor, and the turbine shaft is a first turbine shaft;
the engine core further comprises a second turbine, a second compressor, and a second turbine shaft which connects the second turbine to the second compressor; and
the second turbine, the second compressor, and the second turbine shaft are arranged so as to rotate at a higher rotational speed than the first turbine shaft.

According to a further aspect of the invention, an aircraft is provided with a gas turbine engine according to the invention, wherein the gas turbine engine is arranged on the fuselage of the aircraft or on a wing of the aircraft via an engine mount. It is provided here that the contact surfaces of the bearing support housing are positioned in such a manner that vibrations of the bearing support housing that are produced by the impact of the bearing housing are introduced with a defined preferred direction into the engine mount. This can be achieved via a corresponding orientation of the contact surfaces in the circumferential direction.

The solution according to the invention applies in general to the mounting of shafts on which radial loads can act. Accordingly, the present invention in a further aspect of the invention considers a structural subassembly which has:
a bearing serving for the mounting of a shaft, wherein the bearing comprises a static bearing element,
a bearing housing which surrounds the bearing, wherein the bearing housing is connected to the static bearing element or forms the latter, and
a bearing support housing which surrounds the bearing housing at a radial distance,
wherein the bearing housing enters into contact with the bearing support housing in the event of radial loads acting on the shaft and an associated eccentric revolving movement of the bearing housing,
wherein the bearing support housing forms an inner surface which faces the bearing housing and has at least two flat contact surfaces which are spaced apart in the circumferential direction, wherein, in the event of radial loads acting on the shaft, the bearing housing strikes against the at least two flat contact surfaces during each eccentric revolution, and which in regions outside the flat contact surfaces is spaced apart from the bearing housing in such a manner that there is no contact with the eccentrically revolving bearing housing.

It is pointed out that the present invention is described with reference to a cylindrical coordinate system which has the coordinates x, r, and φ. Here, x indicates the axial direction, r indicates the radial direction, and φ indicates the angle in the circumferential direction. The axial direction is in this case identical to the machine axis of a gas turbine engine in which the structural subassembly is arranged. Proceeding from the x-axis, the radial direction points radially outward. Terms such as “in front of”, “behind”, “front”, and “rear” refer to the axial direction, or the flow direction in the engine. Terms such as “outer” or “inner” refer to the radial direction.

As noted elsewhere herein, the present disclosure may relate to a gas turbine engine. Such a gas turbine engine may comprise an engine core which comprises a turbine, a combustion chamber, a compressor, and a core shaft that connects the turbine to the compressor. Such a gas turbine engine may comprise a fan (having fan blades) which is positioned upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive for the fan so as to drive the fan at a lower rotational speed than the core shaft. The input to the gearbox may be performed directly from the core shaft or indirectly from the core shaft, for example via a spur shaft and/or a spur gear. The core shaft may be rigidly connected to the turbine and the compressor, such that the turbine and the compressor rotate at the same rotational speed (wherein the fan rotates at a lower rotational speed).

The gas turbine engine as described and/or claimed herein may have any suitable general architecture. For example, the gas turbine engine may have any desired number of shafts, for example one, two or three shafts, that connect turbines and compressors. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft which connects the second turbine to the second compressor. The second turbine, the second compressor, and the second core shaft may be arranged so as to rotate at a higher rotational speed than the first core shaft.

In such an arrangement, the second compressor may be positioned so as to be axially downstream of the first compressor. The second compressor may be arranged so as to receive (for example directly receive, for example via a generally annular duct) flow from the first compressor.

The gearbox may be arranged so as to be driven by the core shaft (for example the first core shaft in the example above) that is configured to rotate (for example during use) at the lowest rotational speed. For example, the gearbox may be arranged so as to be driven only by the core shaft (for example only by the first core shaft, and not the second core shaft, in the example above) that is configured to rotate (for example when in use) at the lowest rotational speed. Alternatively thereto, the gearbox may be arranged so as to be driven by one or more shafts, for example the first and/or the second shaft in the example above.

In the case of a gas turbine engine as described and/or claimed herein, a combustion chamber may be provided axially downstream of the fan and of the compressor(s). For example, the combustion chamber may lie directly downstream of the second compressor (for example at the exit of the latter), when a second compressor is provided. By way of further example, the flow at the exit of the compressor may be provided to the inlet of the second turbine, when a second turbine is provided. The combustion chamber may be provided so as to be upstream of the turbine(s).

The or each compressor (for example the first compressor and the second compressor as described above) may comprise any number of stages, for example multiple stages. Each stage may comprise a row of rotor blades and a row of stator blades, which may be variable stator blades (in the sense that the angle of incidence of said variable stator blades may be variable). The row of rotor blades and the row of stator blades may be axially offset from each other.

The or each turbine (for example the first turbine and the second turbine as described above) may comprise any number of stages, for example multiple stages. Each stage may comprise a row of rotor blades and a row of stator blades. The row of rotor blades and the row of stator blades may be axially offset from one another.

Each fan blade may be defined as having a radial span extending from a root (or a hub) at a radially inner location flowed over by gas, or at a 0% span width position, to a tip at a 100% span width position. The ratio of the radius of the fan blade at the hub to the radius of the fan blade at the tip may be less than (or on the order of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range delimited by two of the values in the previous sentence (that is to say that the values may form upper or lower limits). These ratios may be referred to in general as the hub-to-tip ratio. The radius at the hub and the radius at the tip can both be measured at the leading periphery (or the axially frontmost periphery) of the blade. The hub-to-tip ratio refers, of course, to that portion of the fan blade which is flowed over by gas, that is to say the portion that is situated radially outside any platform.

The radius of the fan can be measured between the engine centerline and the tip of the fan blade at the leading periphery of the latter. The diameter of the fan (which may simply be double the radius of the fan) may be larger than (or on the order of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter may be in an inclusive range delimited by two of the values in the previous sentence (that is to say that the values may form upper or lower limits).

The rotational speed of the fan may vary during use. Generally, the rotational speed is lower for fans with a comparatively large diameter. Purely by way of non-limiting example, the rotational speed of the fan at cruise conditions can be less than 2500 rpm, for example less than 2300 rpm. Purely by way of further non-limiting example, the rotational speed of the fan at cruise conditions for an engine having a fan diameter in the range from 250 cm to 300 cm (for example 250 cm to 280 cm) can also be in the range from 1700 rpm to 2500 rpm, for example in the range from 1800 rpm to 2300 rpm, for example in the range from 1900 rpm to 2100 rpm. Purely by way of further non-limiting example, the rotational speed of the fan at cruise conditions for an engine having a fan diameter in the range from 320 cm to 380 cm can be in the range from 1200 rpm to 2000 rpm, for example in the range from 1300 rpm to 1800 rpm, for example in the range from 1400 rpm to 1600 rpm.

During use of the gas turbine engine, the fan (with associated fan blades) rotates about an axis of rotation. This rotation results in the tip of the fan blade moving with a speed Uₜᵢₚ. The work done by the fan blades on the flow results in an enthalpy rise dH in the flow. A fan tip loading can be defined as dH/Uₜᵢₚ², where dH is the enthalpy rise (for example the 1-D average enthalpy rise) across the fan and Uₜᵢₚ is the (translational) speed of the fan tip, for example at the leading periphery of the tip (which can be defined as the fan tip radius at the leading periphery multiplied by the angular speed). The fan tip loading at cruise conditions may be more than (or on the order of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading may be in an inclusive range delimited by two of the values in the previous sentence (that is to say that the values may form upper or lower limits).

Gas turbine engines in accordance with the present disclosure may have any desired bypass ratio, wherein the bypass ratio is defined as the ratio of the mass flow rate of the flow through the bypass duct to the mass flow rate of the flow through the core under cruise conditions. In the case of some arrangements, the bypass ratio may be more than (or on the order of): 10, 10.5, 11, 11.5, 12, 12.5, 13, 13.5, 14, 14.5, 15, 15.5, 16, 16.5, or 17. The bypass ratio may be in an inclusive range delimited by two of the values in the previous sentence (that is to say that the values may form upper or lower limits). The bypass duct may be substantially annular. The bypass duct may be situated radially outside the engine core. The radially outer surface of the bypass duct may be defined by an engine nacelle and/or a fan casing.

The overall pressure ratio of a gas turbine engine as described and/or claimed herein can be defined as the ratio of the stagnation pressure upstream of the fan to the stagnation pressure at the exit of the highest pressure compressor (before entry into the combustion chamber). By way of non-limiting example, the overall pressure ratio of a gas turbine engine as described and/or claimed herein at cruising speed may be greater than (or on the order of): 35, 40, 45, 50, 55, 60, 65, 70, 75. The overall pressure ratio may be in an inclusive range delimited by two of the values in the previous sentence (that is to say that the values can form upper or lower limits).

The specific thrust of an engine can be defined as the net thrust of the engine divided by the total mass flow through the engine. The specific thrust of an engine as described and/or claimed herein at cruise conditions may be less than (or on the order of): 110 Nkg⁻¹ s, 105 Nkg⁻¹ s, 100 Nkg⁻¹ s, 95 Nkg⁻¹ s, 90 Nkg⁻¹ s, 85 Nkg⁻¹ s or 80 Nkg⁻¹ s. The specific thrust may be in an inclusive range delimited by two of the values in the previous sentence (that is to say that the values may form upper or lower limits). Such engines can be particularly efficient in comparison with conventional gas turbine engines.

A gas turbine engine as described and/or claimed herein may have any desired maximum thrust. Purely by way of non-limiting example, a gas turbine as described and/or claimed herein can be capable of generating a maximum thrust of at least (or on the order of): 160 kN, 170 kN, 180 kN, 190 kN, 200 kN, 250 kN, 300 kN, 350 kN, 400 kN, 450 kN, 500 kN, or 550 kN. The maximum thrust may be in an inclusive range delimited by two of the values in the previous sentence (that is to say that the values may form upper or lower limits). The thrust referred to above may be the maximum net thrust at standard atmospheric conditions at sea level plus 15 degrees C. (ambient pressure 101.3 kPa, temperature 30 degrees C.) in the case of a static engine.

In use, the temperature of the flow at the entry to the high-pressure turbine can be particularly high. This temperature, which can be referred to as TET, may be measured at the exit to the combustion chamber, for example directly upstream of the first turbine blade, which in turn can be referred to as a nozzle guide blade. At cruising speed, the TET may be at least (or on the order of): 1400K, 1450K, 1500K, 1550K, 1600K, or 1650K. The TET at cruising speed may be in an inclusive range delimited by two of the values in the previous sentence (that is to say that the values can form upper or lower limits). The maximum TET in the use of the engine can be at least (or on the order of), for example: 1700K, 1750K, 1800K, 1850K, 1900K, 1950K, or 2000K. The maximum TET may be in an inclusive range delimited by two of the values in the previous sentence (that is to say that the values may form upper or lower limits). The maximum TET may occur, for example, under a high thrust condition, for example under a maximum take-off thrust (MTO) condition.

A fan blade and/or an airfoil portion of a fan blade described and/or claimed herein may be manufactured from any suitable material or a combination of materials. For example, at least a part of the fan blade and/or of the airfoil may be manufactured at least in part from a composite, for example a metal matrix composite and/or an organic matrix composite, such as carbon fiber. By way of a further example, at least a part of the fan blade and/or of the airfoil may be manufactured at least in part from a metal, such as a titanium-based metal or an aluminum-based material (such as an aluminum-lithium alloy) or a steel-based material. The fan blade may comprise at least two regions which are manufactured using different materials. For example, the fan blade may have a protective leading periphery, which is manufactured using a material that is better able to resist impact (for example of birds, ice, or other material) than the rest of the blade. Such a leading periphery may, for example, be manufactured using titanium or a titanium-based alloy. Thus, purely by way of example, the fan blade may have a carbon-fiber-based or aluminum-based body (such as an aluminum-lithium alloy) with a titanium leading periphery.

A fan as described and/or claimed herein may comprise a central portion, from which the fan blades may extend, for example in a radial direction. The fan blades may be attached to the central portion in any desired manner. For example, each fan blade may comprise a fixing device which can engage with a corresponding slot in the hub (or disk). Purely by way of example, such a fixing device may be in the form of a dovetail that can be inserted into and/or engage with a corresponding slot in the hub/disk in order for the fan blade to be fixed to the hub/disk. By way of a further example, the fan blades may be formed integrally with a central portion. Such an arrangement may be referred to as a blisk or a bling. Any suitable method may be used to manufacture such a blisk or such a bling. For example, at least a part of the fan blades may be machined from a block and/or at least a part of the fan blades may be attached to the hub/disk by welding, such as linear friction welding.

The gas turbine engines described and/or claimed herein may or may not be provided with a variable area nozzle (VAN). Such a variable area nozzle can allow the exit cross section of the bypass duct to be varied during use. The general principles of the present disclosure can apply to engines with or without a VAN.

The fan of a gas turbine as described and/or claimed herein may have any desired number of fan blades, for example 16, 18, 20, or 22 fan blades.

As used herein, cruise conditions can mean cruise conditions of an aircraft to which the gas turbine engine is attached. Such cruise conditions can be conventionally defined as the conditions at mid-cruise, for example the conditions experienced by the aircraft and/or the engine between (in terms of time and/or distance) the top of climb and the start of descent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the cruise conditions may correspond to standard atmospheric conditions at an altitude that is in the range from 10,000 m to 15,000 m, for example in the range from 10,000 m to 12,000 m, for example in the range from 10,400 m to 11,600 m (around 38,000 ft), for example in the range from 10,500 m to 11,500 m, for example in the range from 10,600 m to 11,400 m, for example in the range from 10,700 m (around 35,000 ft) to 11,300 m, for example in the range from 10,800 m to 11,200 m, for example in the range from 10,900 m to 11,100 m, for example on the order of 11,000 m. The cruise conditions may correspond to standard atmospheric conditions at any given altitude in these ranges.

Purely by way of example, the cruise conditions may correspond to the following: a forward Mach number of 0.8; a pressure of 23,000 Pa; and a temperature of −55 degrees C.

As used anywhere herein, “cruising speed” or “cruise conditions” may mean the aerodynamic design point. Such an aerodynamic design point (or ADP) may correspond to the conditions (including, for example, the Mach number, environmental conditions, and thrust requirement) for which the fan operation is designed. This may mean, for example, the conditions under which the fan (or the gas turbine engine) has the optimum efficiency in terms of construction.

During use, a gas turbine engine described and/or claimed herein may be operated at the cruise conditions defined elsewhere herein. Such cruise conditions may be determined by the cruise conditions (for example the conditions during the middle part of the flight) of an aircraft to which at least one (for example 2 or 4) gas turbine engine(s) can be fastened in order to provide the thrust force.

It is self-evident to a person skilled in the art that a feature or parameter described in relation to any one of the above aspects may be applied to any other aspect, unless they are mutually exclusive. Furthermore, any feature or any parameter described here may be applied to any aspect and/or combined with any other feature or parameter described here, unless they are mutually exclusive.

The invention will be explained in more detail below on the basis of a plurality of exemplary embodiments with reference to the figures of the drawing. In the drawing:

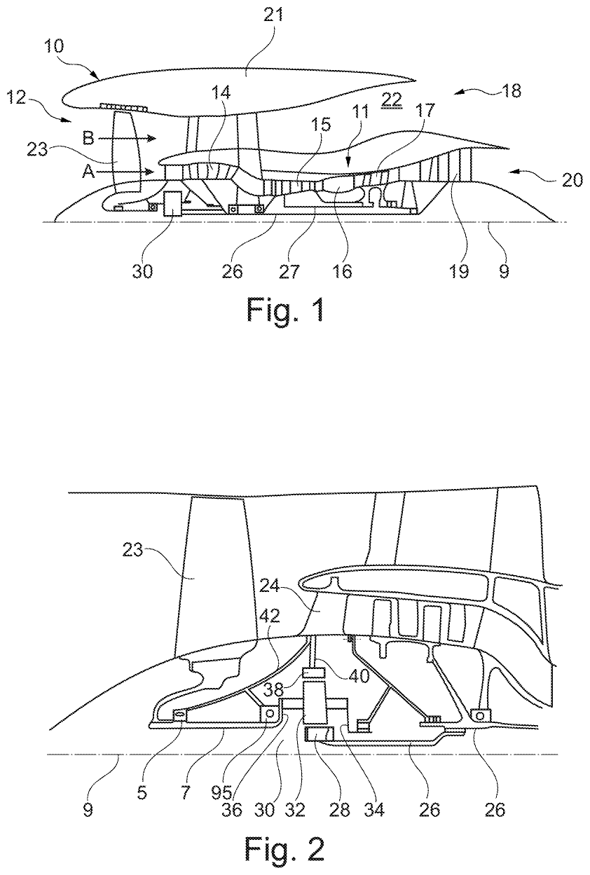

FIG. 1 shows a sectional lateral view of a gas turbine engine;

FIG. 2 shows a close-up sectional lateral view of an upstream portion of a gas turbine engine;

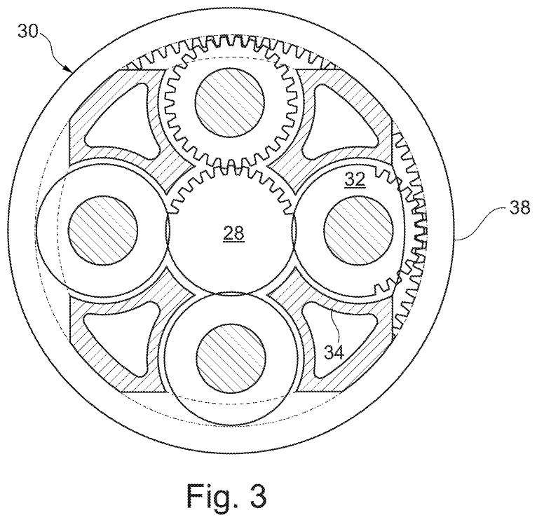

FIG. 3 shows a partially cut-away view of a gearbox for a gas turbine engine;

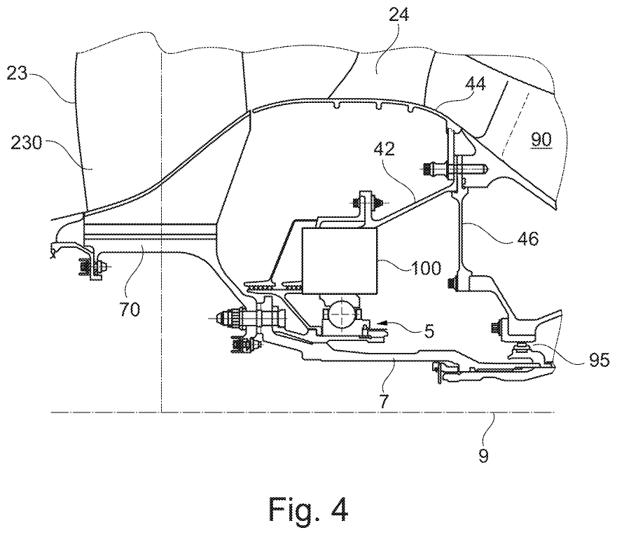

FIG. 4 schematically shows the arrangement of a structural subassembly for transmitting radial loads acting on a bearing of the fan shaft, in a gas turbine engine;

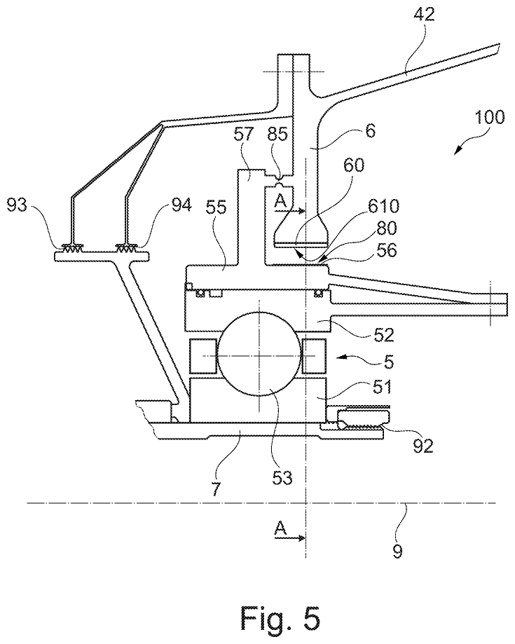

FIG. 5 shows an exemplary embodiment of the structural subassembly according to FIG. 4 for transmitting radial loads, wherein the structural subassembly comprises a bearing housing and a bearing support housing;

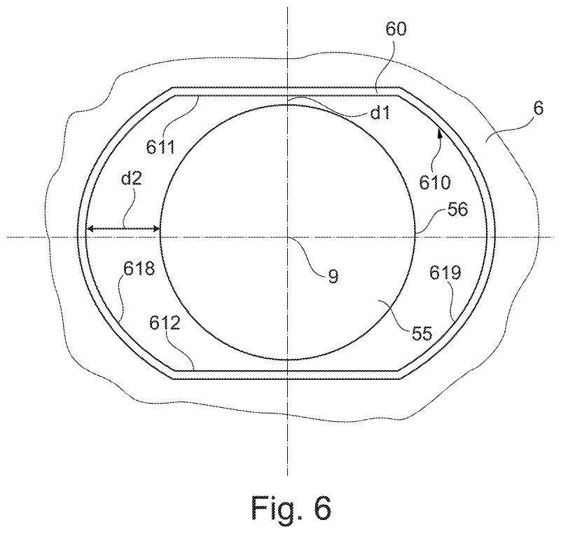

FIG. 6 shows a sectional view along the line A-A of FIG. 5 of a first variant embodiment of the design of the contact surfaces of the bearing support housing, against which the bearing housing strikes during an eccentric revolution, wherein the bearing support housing forms two contact surfaces;

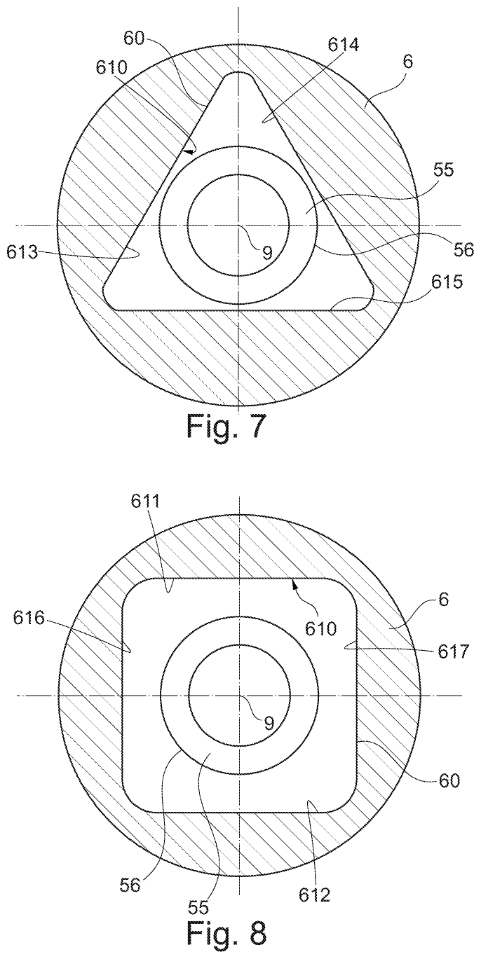

FIG. 7 shows a sectional view along the line A-A of FIG. 5 of a second variant embodiment of the design of the contact surfaces of the bearing support housing, against which the bearing housing strikes during an eccentric revolution, wherein the bearing support housing forms three contact surfaces;

FIG. 8 shows a sectional view along the line A-A of FIG. 5 of a third variant embodiment of the design of the contact surfaces of the bearing support housing, against which the bearing housing strikes during an eccentric revolution, wherein the bearing support housing forms four contact surfaces; and

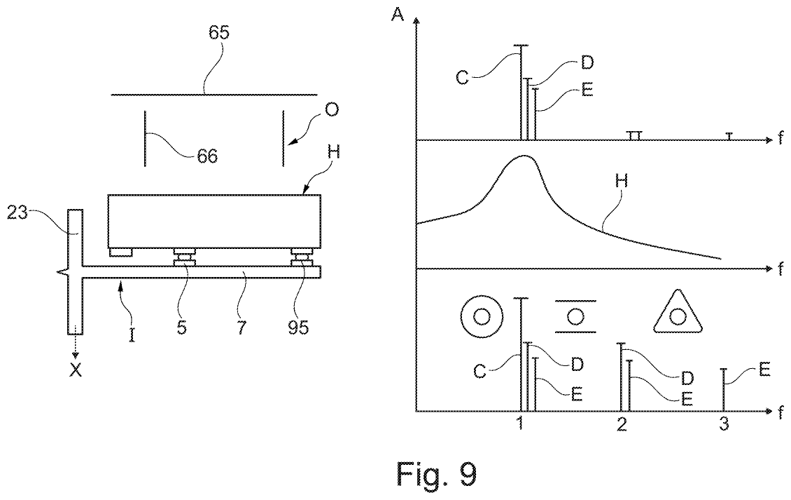

FIG. 9 shows schematically the influencing of a transmission function, which describes the transmission of vibrations between the fan shaft and an engine mount, by a structural subassembly according to FIGS. 4 to 8.

FIG. 1 illustrates a gas turbine engine 10 having a main axis of rotation 9. The engine 10 comprises an air intake 12 and a thrust fan or fan 23 that generates two air flows: a core air flow A and a bypass air flow B. The gas turbine engine 10 comprises a core 11 which receives the core air flow A. In the sequence of axial flow, the engine core 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 by way of a shaft 26 and an epicyclic gearbox 30.

During use, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resultant hot combustion products then expand through, and thereby drive, the high-pressure and low-pressure turbines 17, 19 before being expelled through the nozzle 20 to provide some thrust force. The high-pressure turbine 17 drives the high-pressure compressor 15 by means of a suitable connecting shaft 27. The fan 23 generally provides the major part of the thrust force. The epicyclic gearbox 30 is a reduction gearbox.

An exemplary arrangement for a geared fan gas turbine engine 10 is shown in FIG. 2. The low-pressure turbine 19 (see FIG. 1) drives the shaft 26, which is coupled to a sun gear 28 of the epicyclic gearbox assembly 30. Radially to the outside of the sun gear 28 and meshing therewith is a plurality of planet gears 32 that are coupled to one another by a planet carrier 34. The planet carrier 34 limits the planet gears 32 to orbiting around the sun gear 28 in a synchronous manner while enabling each planet gear 32 to rotate about its own axis. The planet carrier 34 is coupled by way of linkages 36 to the fan 23 so as to drive the rotation of the latter about the engine axis 9. Radially to the outside of the planet gears 32 and meshing therewith is an annulus or ring gear 38 that is coupled, via linkages 40, to a stationary supporting structure 24.

It is noted that the terms “low-pressure turbine” and “low-pressure compressor” as used herein can be taken to mean the lowest-pressure turbine stage and the lowest-pressure compressor stage (that is to say not including the fan 23) respectively and/or the turbine and compressor stages that are connected to one another by the connecting shaft 26 with the lowest rotational speed in the engine (that is to say not including the gearbox output shaft that drives the fan 23). In some literature, the “low-pressure turbine” and the “low-pressure compressor” referred to herein may alternatively be known as the “intermediate-pressure turbine” and “intermediate-pressure compressor”. Where such alternative nomenclature is used, the fan 23 can be referred to as a first compression stage or lowest-pressure compression stage.

The epicyclic gearbox 30 is shown in an exemplary manner in greater detail in FIG. 3. Each of the sun gear 28, the planet gears 32 and the ring gear 38 comprise teeth about their periphery to mesh with the other gears. However, for clarity, only exemplary portions of the teeth are illustrated in FIG. 3. There are four planet gears 32 illustrated, although it will be apparent to the person skilled in the art that more or fewer planet gears 32 can be provided within the scope of protection of the claimed invention. Practical applications of an epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, wherein the ring gear 38 is fixed. However, any other suitable type of epicyclic gearbox 30 may be used. By way of a further example, the epicyclic gearbox 30 may be a star arrangement, in which the planet carrier 34 is held so as to be fixed, wherein the ring gear (or annulus) 38 is allowed to rotate. In the case of such an arrangement, the fan 23 is driven by the ring gear 38. By way of a further alternative example, the gearbox 30 can be a differential gearbox in which the ring gear 38 and the planet carrier 34 are both allowed to rotate.

It is self-evident that the arrangement shown in FIGS. 2 and 3 is merely an example, and various alternatives fall within the scope of protection of the present disclosure. Purely by way of example, any suitable arrangement may be used for positioning the gearbox 30 in the engine 10 and/or for connecting the gearbox 30 to the engine 10. By way of a further example, the connections (such as the linkages 36, 40 in the example of FIG. 2) between the gearbox 30 and other parts of the engine 10 (such as the input shaft 26, the output shaft and the fixed structure 24) may have a certain degree of stiffness or flexibility. By way of a further example, any suitable arrangement of the bearings between rotating and stationary parts of the engine (for example between the input and output shafts of the gearbox and the fixed structures, such as the gearbox casing) may be used, and the disclosure is not limited to the exemplary arrangement of FIG. 2. For example, where the gearbox 30 has a star arrangement (described above), the person skilled in the art would readily understand that the arrangement of output and support linkages and bearing positions would typically be different to that shown by way of example in FIG. 2.

Accordingly, the present disclosure extends to a gas turbine engine having an arbitrary arrangement of gearbox types (for example star-shaped or planetary), support structures, input and output shaft arrangement, and bearing positions.

Optionally, the gearbox may drive additional and/or alternative components (e.g. the intermediate-pressure compressor and/or a booster compressor).

Other gas turbine engines to which the present disclosure can be applied may have alternative configurations. For example, engines of this type may have an alternative number of compressors and/or turbines and/or an alternative number of connecting shafts. By way of a further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed-flow nozzle. One or both nozzles (whether mixed or split flow) may have a fixed or variable area. While the example described relates to a turbofan engine, the disclosure may be applied, for example, to any type of gas turbine engine, such as an open-rotor engine (in which the fan stage is not surrounded by an engine nacelle) or a turboprop engine. In some arrangements, the gas turbine engine 10 may not comprise a gearbox 30.

The geometry of the gas turbine engine 10, and components thereof, is/are defined by a conventional axis system, comprising an axial direction (which is aligned with the axis 9 of rotation), a radial direction (in the bottom-to-top direction in FIG. 1), and a circumferential direction (perpendicular to the view in FIG. 1). The axial, radial and circumferential directions run so as to be mutually perpendicular.

FIG. 2 also shows the fan shaft 7 which is coupled on the output side to the planetary gearbox 30 and is mounted by means of a front bearing 5 and a rear bearing 95. The static components of the bearings 5, 95 are connected here to a fan housing 42 which is part of the stationary support structure 24. It is noted here that the stationary support structure 24 is connected to an engine mount via which the gas turbine engine is secured on the fuselage of the aircraft or on a wing of the aircraft.

In the context of the present invention, the design and coupling of the front bearing 5 to the fan housing 42 and in general to the stationary support structure 24 is of importance in the event of the loss of a fan blade of the fan 23.

FIG. 4 clarifies the arrangement of a structural subassembly 100 via which the front bearing 5 of the fan shaft 7 of a gas turbine engine is coupled to a stationary support structure 24 of the gas turbine engine. Unlike in the exemplary embodiment of FIGS. 1 to 3, the gas turbine engine illustrated is not equipped here with a planetary gearbox. On the contrary, the low-pressure shaft driven by the low-pressure turbine drives the fan 23 without a gear reduction. The present invention can be used both in gas turbine engines having a reduction gearbox and in gas turbine engines without a reduction gearbox.

Corresponding to FIG. 2, FIG. 4 shows the fan shaft 7, the front bearing 5 and the rear bearing 95. The fan shaft 7 forms an outer ring 70 axially at the front, to which the fan blades 230 of the fan 23 are fastened or with which they are integrally formed.

The front bearing 5 is connected via the structural subassembly 10, merely illustrated as a functional block, to the fan housing 42 which is part of the supporting support structure 24. Further elements of the support structure that are illustrated are a hub 44 which limits the primary flow duct 90 through the core engine radially on the inside, and wall regions 46 via which the static components of the rear bearing 95 are connected to the support structure 24.

FIG. 5 shows an exemplary embodiment of a structural subassembly 100 via which the front bearing 5 of the fan shaft 7 is coupled to the fan housing 42. The bearing 5 comprises a rotating inner ring 51 connected fixedly to the shaft 7, a static outer ring 52 and rolling bodies 53 which are arranged in between and are designed, for example, as balls. However, this configuration of the bearing 5 should be understood as being merely by way of example.

The bearing 5 furthermore has a bearing housing 55 which is fixedly connected to the outer ring 52 or is formed integrally therewith. The bearing housing 55 is assigned a bearing support housing 6. Firstly, there is a direct connection here between the bearing housing 55 and the bearing support housing, which connection is produced by shearing pins 85 which extend between a radial extension 57 of the bearing housing 55 and the bearing support housing 6. The shearing pins 85 have a predetermined breaking point which causes the shearing pins 85 to shear off in the event of powerful radial relative movements between the bearing housing 55 and the bearing support housing 6. The shearing pins 85 are designed here to the effect that they shear off whenever, in the event of the loss of a fan blade, the bearing housing 55 revolves eccentrically.

Secondly, the bearing housing 55 and the bearing support housing 6 are coupled via a mechanism which is used only when the shearing pins 85 shear off. This mechanism comprises a contact sleeve 60 which forms the bearing support housing 6 on the side thereof facing the bearing housing 55. The contact sleeve 60 here forms an inner surface 610 which faces the bearing housing 55.

Radially opposite and spaced apart from the inner surface 610 of the contact sleeve 60, the bearing housing 55 forms a bearing housing contact surface 56 on its outer side. Said bearing housing contact surface 56 can be provided with a coating 80, for example composed of tungsten carbide, which increases the local yield strength of the bearing housing contact surface.

The operating principle of the coupling between the bearing housing 55 and the bearing support housing 6 is first apparent in the sectional illustration along the plane A-A, wherein the plane A-A extends perpendicularly to the axis of rotation of the fan or machine axis 9.

The situation in which, after loss of a blade, powerful revolving radial loads are introduced into the fan shaft 7 because of the imbalance in the fan plane, is considered here. Said radial loads lead to the statically arranged bearing housing 55 carrying out an eccentric revolving movement, which may also be referred to as orbiting. This does not involve a rotation, since the bearing housing 55 is arranged statically, but rather a revolving eccentric deflection in the radial direction. This leads to breaking or shearing off of the shearing pins 85. The shearing off of the shearing pins 85 leads to an interruption of the connection between the bearing 5 and the fan housing 42 or the supporting structure of the engine. A direct transmission of the radial loads which occur into the supporting structure of the engine is therefore prevented.

Instead, the bearing housing contact surface 56 of the bearing housing 55 now enters intermittently into contact with the contact sleeve 60 of the bearing support housing 6. FIGS. 6 to 8 show three different exemplary embodiments in this regard, wherein these figures each illustrate a sectional illustration along the plane A-A of FIG. 5.

FIG. 6 shows the bearing support housing 6 which is arranged spaced apart radially from the bearing housing 55. The fan shaft and the components of the bearing 5 which are located radially within the bearing housing contact surface 56 not illustrated in FIG. 6. In this respect, the illustration of FIG. 6 is schematic. Not schematic, however, is the fact that the bearing housing contact surface 56 is circular in the sectional illustration under consideration.

Corresponding to the illustration of FIG. 5, the bearing support housing 9 forms a contact sleeve 60 which, radially on the inside, forms an inner surface 610 facing the bearing housing 55. In the plane under consideration perpendicular to the axis of rotation of the fan shaft, the contact sleeve 60 surrounds the bearing housing 5 over an angular range of 360°, i.e. completely in the circumferential direction.

The inner surface 610 of the contact sleeve 60, said inner surface encircling in the circumferential direction, comprises a plurality of differently shaped surfaces. It thus comprises two flat contact surfaces 611, 612 which, in a horizontal orientation of the engine, extend in the horizontal direction and are spaced apart in the vertical direction. The two contact surfaces 611, 612 run parallel here. Furthermore, the inner surface comprises two curved surfaces 618, 619 which connect the flat contact surfaces 611, 612. It is the case here that the minimum distance d1 between the bearing housing contact surface 56 and the flat contact surfaces 611, 612 is smaller than the maximum distance d2 between the bearing housing contact surface 56 and the curved surfaces 618, 619. For example, the distance d2 is at least 4 times to 10 times the distance d1.

Furthermore, it is noted that the contact sleeve 60 is composed of a hard material which has, for example, a Vickers hardness of at least 300 HV 10. The contact sleeve 60 is also not connected to an elastic material or damping material or the like. The contact sleeve 60 thus does not have any significant damping properties.

During an eccentric revolving movement of the bearing housing 55 after the shearing pins 85 have sheared off, the bearing housing 55 comes intermittently into contact with the bearing support housing 6, specifically to the effect that it strikes alternately by means of its bearing housing contact surface 56 against the two flat contact surfaces 611, 612, wherein, during each eccentric revolution about 360°, the bearing housing 55 in each case collides once with said two contact surfaces 611, 612. By contrast, there is no contact with the eccentrically revolving bearing housing 55 in those regions 618, 619 of the inner surface 610 of the contact sleeve 60 which are arranged at a greater radial distance from the surface 56 of the bearing housing 55. This ensures that the respective contact is a radial strike against the respective contact surface 611, 612.

This repeated exertion of a radial force on the bearing support housing 6 by the bearing housing 55 and therefore in the supporting structure 42, 24 of the engine changes the vibration pattern. The vibration pattern is thus transferred from a first excitation order into a second excitation order since the revolving housing 55 which revolves with a first excitation order exerts two radial impacts per revolution on the bearing support housing 6. The impacts formed by the bearing housing on the contact surfaces 611, 612 therefore form vibrations of a higher order in the supporting structure of the engine.

The load amplitudes which the engine mount has to sustain are thereby reduced. The vibration energy which, without the invention, is concentrated in the first vibration order is split between vibration orders of a higher order. The maximum loads which act on the engine mount are thereby reduced.

It is noted here that the orientation of the flat contact surfaces 611, 612 predetermines a direction in which vibrations are transmitted into the engine. In the exemplary embodiment illustrated in FIG. 6, the vibrations are transmitted upwards and downwards in the vertical direction into the supporting structure of the engine. This direction can be predetermined or set by a change in the orientation of the contact surfaces 611, 612. For example, if the flat contact surfaces 611, 612 were arranged rotated by 45° in the clockwise direction in comparison to the illustration of FIG. 6, the vibrations would be transmitted with a correspondingly changed direction into the supporting structure of the engine.

FIG. 7 shows an alternative exemplary embodiment for the design of contact surfaces on the inner side 610 of the contact sleeve 60 of the bearing support housing 6. The bearing housing 55 which runs coaxially with respect to the axis of rotation 9 and has a circular bearing housing contact surface 56 is again illustrated schematically. The bearing components arranged radially on the inside with respect to the bearing housing 55 and the fan shaft are again not illustrated.

In the exemplary embodiment of FIG. 7, the contact sleeve 60 forms three flat contact surfaces 613, 614, 615 which are arranged at an angle of 120° to one another, corresponding to the sides of an equilateral triangle. Such an arrangement leads to the bearing housing 55 in each case colliding once with the three contact surfaces 613, 614, 615 during each eccentric revolution through 360°. By contrast, there is no contact with the eccentrically revolving bearing housing 55 in those regions of the inner surface 610 of the contact sleeve 60 which lie in between and are arranged at a greater radial distance from the surface 56 of the bearing housing 55.

This repeated exertion of a radial force on the bearing support housing 6 by the bearing housing 55 and therefore in the supporting structure 42, 24 of the engine again changes the vibration pattern. The vibration pattern is thus transferred from a first excitation order into a third excitation order since the revolving housing 55 exerts three radial impacts per revolution on the bearing support housing 6.

FIG. 8 shows a further alternative exemplary embodiment. For the basic construction, reference is made to the description of FIGS. 6 and 7. In the exemplary embodiment of FIG. 8, the contact sleeve 6 on its inner surface 610 forms four flat contact surfaces 611, 612, 616, 617 which are arranged at an angle of 90° to one another, corresponding to the four sides of a square. Such an arrangement leads to the bearing housing 55 in each case colliding once with the four contact surfaces 611, 612, 616, 617 during each eccentric revolution through 360°. By contrast, there is no contact with the eccentrically revolving bearing housing 55 in those regions of the inner surface 610 of the contact sleeve 60 which lie in between and are arranged at a greater radial distance from the surface 56 of the bearing housing 55.

This repeated exertion of a radial force on the bearing support housing 6 by the bearing housing 55 and therefore in the supporting structure 42, 24 of the engine again changes the vibration pattern. The vibration pattern is thus transferred from a first excitation order into a fourth excitation order since the revolving housing 55 exerts four radial impacts on the bearing support housing 6 per revolution.

It is also true for the exemplary embodiments of FIGS. 7 and 8 that a correspondingly rotated positioning of the contact surfaces can define preferred directions in which the radial pulses exerted on the bearing support housing 6 by the gearbox housing 55 are transmitted.

FIG. 9 schematically shows the effects of the structural subassembly according to the invention on the forces acting on the engine mount. The system comprises an intake I which is formed by the fan shaft 7 with the fan 23. An exit O of the system is formed by an engine mount 66 which connects the engine to a component 65 of an aircraft. Intake I and exit O are coupled to each other via the structural subassembly according to the invention and a support structure which can be described via a transmission function H. A malfunction X in the form of a partial or complete loss of a blade is observed here in the fan 23. The malfunction X causes a vibration in the first vibration order in the system via the bearings 5, 95.

At the bottom right in the illustration, FIG. 9 shows the frequency components at the intake I for the situations C, D and E, wherein situation C refers to the situation in which there is no coupling according to the invention between the bearing housing and the bearing support housing, situation D refers to the situation in which coupling takes place via two flat contact surfaces, and E refers to the situation in which coupling takes place via three flat contact surfaces.

In situation C, the entire vibration energy is concentrated in the first vibration order 1. In situation D, the vibration energy is split between the two first vibration orders 1 and 2. It should be noted here that the vibration order 1 furthermore contains energy, for example because corresponding vibrations are transmitted via the rear bearing 95 into the system. In situation E, the vibration energy is split between the three first vibration orders 1, 2 and 3.

The transmission function H to an increased extent weakens the higher frequencies according to the vibration orders 2 and 3. Accordingly, the amplitudes of the frequencies at the exit O for the frequencies of the vibration orders 2 and 3 are significantly weakened in accordance with the illustration at the top right of FIG. 9. Vibrations of the vibration order 1 that are significantly reduced by the amplitude in comparison to situation C remain. The maximum loads which act on the engine mount 66 are therefore significantly reduced.

It is self-evident that the invention is not limited to the embodiments described above and that various modifications and improvements may be made without departing from the concepts described herein. It is also pointed out that any of the features described may be used separately or in combination with any other features, unless they are mutually exclusive. The disclosure also extends to and comprises all combinations and sub-combinations of one or a plurality of features which are described here. If ranges are defined, said ranges thus comprise all of the values within said ranges as well as all of the partial ranges that lie in a range.

1. Structural subassembly for a gas turbine engine, which has:
a bearing serving for the mounting of the fan shaft of a gas turbine engine, wherein the bearing comprises a static bearing element,
a bearing housing which surrounds the bearing, wherein the bearing housing is connected to the static bearing element or forms the latter, and
a bearing support housing which surrounds the bearing housing at a radial distance and which is connected to a supporting structure of the gas turbine engine,
wherein, in the event of the loss of a fan blade, the bearing housing enters into contact with the bearing support housing because of an eccentric revolving movement of the bearing housing then occurring,
wherein the bearing support housing forms an inner surface which faces the bearing housing and
has at least two flat contact surfaces which are spaced apart in the circumferential direction, wherein, in the event of the loss of a fan blade, the bearing housing strikes against the at least two flat contact surfaces during each eccentric revolution, and
in regions outside the flat contact surfaces is spaced apart from the bearing housing in such a manner that there is no contact with the eccentrically revolving bearing housing.

2. Structural subassembly according to claim 1, wherein the bearing support housing has a contact sleeve which surrounds the bearing housing in the radial direction and forms the inner surface facing the bearing housing and the at least two flat contact surfaces in said inner surface.

3. Structural subassembly according to claim 2, wherein the contact sleeve surrounds the bearing housing over an angular range of 360° in a plane perpendicular to the axis of rotation of the fan shaft.

4. Structural subassembly according to claim 1, wherein the bearing support housing has two flat contact surfaces which run parallel to each other and are arranged lying opposite with respect to the axis of rotation of the fan shaft.

5. Structural subassembly according to claim 1, wherein the bearing support housing has three flat contact surfaces.

6. Structural subassembly according to claim 5, wherein the three flat contact surfaces in a sectional illustration perpendicular to the axis of rotation of the fan shaft are oriented with respect to one another corresponding to the three sides of an equilateral triangle, wherein the axis of rotation of the fan shaft lies at the center point of the equilateral triangle.

7. Structural subassembly according to claim 1, wherein the bearing support housing has four flat contact surfaces.

8. Structural subassembly according to claim 7, wherein the four flat contact surfaces in a sectional illustration perpendicular to the axis of rotation of the fan shaft are oriented with respect to one another corresponding to the four sides of a square, wherein the axis of rotation of the fan shaft lies at the centre point of the square.

9. Structural subassembly according to claim 4, wherein the contact surfaces are positioned in such a manner that vibrations of the bearing support housing that are produced by the impact of the bearing housing are produced with a defined preferred direction and are transported via the bearing support housing.

10. Structural subassembly according to claim 9, wherein the two flat contact surfaces which are arranged parallel to each other are rotated by a defined angle in relation to a horizontal orientation.

11. Structural subassembly according to claim 1, wherein the bearing housing and the bearing support housing are connected to each other via shearing pins, wherein the shearing pins are designed in such a manner that they shear off in the event of the loss of a fan blade because of an eccentric revolving movement of the bearing housing then occurring.

12. Structural subassembly according to claim 1, wherein the contact surfaces have a Vickers hardness of at least 300 HV 10.

13. Structural subassembly according to claim 1, wherein the contact surfaces are not connected to a damping material or mounted in a floating manner.

14. Structural subassembly according to claim 1, wherein the bearing housing has a bearing housing contact surface which revolves by 360° and enters into contact with the contact surfaces of the bearing support housing during an eccentric revolving movement of the bearing housing.

15. Structural subassembly according to claim 14, wherein the bearing housing contact surface in a sectional illustration perpendicular to the axis of rotation of the fan shaft is circular.

16. Structural subassembly according to claim 14, wherein the bearing housing contact surface is provided with a coating which increases the local yield strength of the bearing housing contact surface.

17. Gas turbine engine having a structural subassembly according to claim 1.

18. Gas turbine engine according to claim 16, which has:
an engine core which comprises a turbine, a compressor having a structural subassembly, and a turbine shaft which is configured as a hollow shaft and connects the turbine to the compressor;
a fan, which is positioned upstream of the engine core, wherein the fan comprises a plurality of fan blades; and
a gearbox that receives an input from the turbine shaft and outputs drive for the fan so as to drive the fan at a lower rotational speed than the turbine shaft.

19. Aircraft with a gas turbine engine according to claim 17, wherein the gas turbine engine is arranged on the fuselage of the aircraft or on a wing of the aircraft via an engine mount, wherein the contact surfaces of the bearing support housing are positioned in such a manner that vibrations of the bearing support housing that are produced by the impact of the bearing housing are introduced with a defined preferred direction into the engine mount.

20. Structural subassembly, which has:
a bearing serving for the mounting of a shaft, wherein the bearing comprises a static bearing element,
a bearing housing which surrounds the bearing, wherein the bearing housing is connected to the static bearing element or forms the latter, and
a bearing support housing which surrounds the bearing housing at a radial distance,
wherein the bearing housing enters into contact with the bearing support housing in the event of radial loads acting on the shaft and an associated eccentric revolving movement of the bearing housing,
wherein the bearing support housing forms an inner surface which faces the bearing housing and which
has at least two flat contact surfaces which are spaced apart in the circumferential direction, wherein, in the event of radial loads acting on the shaft, the bearing housing strikes against the at least two flat contact surfaces during each eccentric revolution, and
in regions outside the flat contact surfaces is spaced apart from the bearing housing in such a manner that there is no contact with the eccentrically revolving bearing housing.
